(19) United States
(12) Patent Application Publication
(10) Pub. No.: US 2013/0127656 A1
(43) Pub. Date: May 23, 2013

(54) RADAR FILTER

(71) Applicants: Craig Duncan Webster, Cambridge (GB); Gordon Kenneth Andrew Oswald, Cambridge (GB)

(72) Inventors: Craig Duncan Webster, Cambridge (GB); Gordon Kenneth Andrew Oswald, Cambridge (GB)

(73) Assignee: CAMBRIDGE CONSULTANTS LTD., Cambridge (GB)

(21) Appl. No.: 13/641,821

(22) PCT Filed: Apr. 19, 2011
(86) PCT No.: PCT/GB11/50778

§ 371 Date: Feb. 1, 2013

(30) Foreign Application Priority Data
Apr. 19, 2010 (GB) 1006503.5

(51) Int. Cl. G01S 7/41

(52) U.S. Cl. CPC G01S 7/414
USPC 342/159

(57) ABSTRACT

A method of filtering radar return signals to discriminate between targets of interest and clutter is presented in which a filter filters radar return signals received by a first radar receiver, based on radar return signals received at another radar receiver, to produce filtered radar return data in which radar return signals received by the first radar receiver for targets of interest are present and radar return signals received by the first radar receiver but arising from clutter are suppressed.

The present invention relates to a method of and apparatus for filtering radar return signals and, in particular, a method of and apparatus for filtering radar return signals to discriminate between targets of interest and clutter.

It is well known that finding suitable sites for locating wind turbines, or collections of wind turbines (wind farms), is a major challenge facing those wishing to increase the provision of electricity derived from wind power. At present, this issue is compounded by the need to ensure that the wind turbines are located at sites where they are unlikely to cause significant interference to the effective operation of air traffic control radar systems or other such surveillance radar systems. With current surveillance radar systems, as an aircraft flies above a wind farm, both the anomalous radar returns from wind turbines (clutter) and the returns of interest from the aircraft are displayed. In some cases, the clutter becomes indistinguishable from genuine objects of interest such as aircraft.

This need to avoid radar interference can result in otherwise suitable sites being avoided, thereby effectively reducing the geographical area available for the exploitation of wind energy.

In order to mitigate these issues, therefore, there is a need to provide improved methods and/or apparatus which are capable of mitigating the effects of interference associated with wind turbines or wind farms (or indeed other cluttered environments) on radar installations and in particular air traffic control radar systems or other such surveillance radar systems.

The present invention seeks to provide such methods and/or apparatus.

### Possible Approaches

One approach to addressing the issue of radar interference from wind farms (or other cluttered environments) is to combine the radar data obtained at a radar installation affected by the interference with data obtained at a further ‘infill’ radar installation which is not prone to the same interference. In this scenario, radar data received at the affected radar installation, for the region containing the wind farm, is replaced by radar data which is unaffected (or less affected) by the wind turbine related clutter, as received for the same region, at the infill radar installation. Thus, the radar data that would otherwise be displayed in a position affected by the wind farm clutter, on an operator's screen, is effectively replaced with radar data that is substantially free from clutter. This method of data combination is referred to herein as Mosaicing.

The sensor of the infill radar installation may be unaffected by the wind turbine induced interference simply because the infill radar's sensor is positioned such that the wind turbines are masked from the line of sight of the sensor. A more satisfactory solution, however, is to use a three dimensional (3D) radar which is capable of establishing a target's position in three dimensions (e.g. by reference to range, azimuth, and/or elevation angle) such as that described in international patent published as WO2009144435 (A1), and which is specifically designed to be able to discriminate objects of interest from clutter.

The fusion of data from a plurality of radar sensors may be used, for example, to create tracks on a radar screen, for example by using ‘tracker’ algorithms to combine the signals from the different radar sensors and display symbols representing objects of interest, and their historical trajectory, on a radar display screen. The tracking algorithms may, for example, use a combination of radar return signals for a particular target aircraft from a plurality of two dimensional ‘2D’ primary surveillance radars (PSRs) at different geographical locations, and signals that include altitude data transmitted by the aircraft received via secondary surveillance apparatus. This approach is commonly referred to as Multi-Radar tracking (MRT) and is used to create a ‘Recognised Air Picture’ of all of the aircraft in a particular area. Recognised Air Pictures are used by National Air Traffic Control and Defence Organisations.

2D PSRs, such as those used for air traffic control, determine the approximate position of a target aircraft in two dimensions based on the range and the azimuth of the aircraft relative to the radar. However, 2D PSRs measure the ‘slant’ range of an aircraft (the distance from the radar to the aircraft along the aircraft's angle of elevation) rather than the ‘ground’ distance to the aircraft's ground position (e.g. as defined by the aircraft's latitude and longitude). Accordingly, relatively large errors can result in the measured ground position. Thus, when the outputs from a plurality of 2D PSRs at different geographical locations are combined, it can result in the returns for a single target aircraft being erroneously displayed at two different locations on an operator's screen and/or the track of an aircraft becoming dislocated at the transition between the regions covered by the different PSRs. Tracker algorithms used to create Recognised Air Pictures are designed to make the best approximation of these errors to estimate a target's position but these algorithms are complex and scope for error remains

The issue with the use of a 2D PSR can be mitigated by the use of a three dimensional ‘3D’ radar, such as that described in WO2009144435 (A1), which allows an accurate three dimensional position to be determined for a target aircraft based on the range, the azimuth, and the angle of elevation of the aircraft relative to the radar. The 3D radar can thus be used to provide infill data to a 2D PSR, which infill data can, by virtue of the measured angle of elevation, be subject to a mathematical transformation to ensure that the target aircraft is reported in the same reference plane as the 2D PSR. Accordingly, the target aircraft's azimuth and range are reported by the 3D radar substantially as they would be measured by the 2D PSR. This allows a localised section of data to be replaced by data from the 3D infill radar, on the display of the 2D PSR, with minimal dislocation at the transition between sensors.

The fusion (or ‘Mosaicing’) of data for radar installations in which raw ‘video’ is displayed on an operator's screen, however, can be more challenging. In such installations, the actual ‘raw’ radar returns received at the PSR are displayed (or ‘painted’) directly on an operator's display. Accordingly, replacing a localised segment of the display with raw data from another radar sensor is likely to result in anomalies being exhibited, which anomalies are particularly apparent at the transition between the infill segment and the rest of the display. These anomalies may arise, for example, from the different frames of reference associated with the different geographical locations of the radar installations from which the fused data originates.

An issue with the proliferation of wind farms and the need for more Infill Radars is that the infrastructure and equipment associated with the creation of Recognised Air Pictures for Air Traffic Control and Defence organisations is designed to accommodate the maximum number of sensors deemed adequate prior to the growth of the wind industry and would require extensive costly modification to enable the addition of the extra Infill radars for wind farms.

Accordingly, the present invention seeks to provide, amongst other things, improvements in the way in which data from one or more radar sensors is used with that of a PSR to display radar return data to a radar operator.

Further, in at least one aspect, the present invention seeks to provide, amongst other things, an improved method that might be used to contribute to enabling proliferation of Infill radars for wind farms clutter mitigation to be achieved without the need for extensive and costly modifications to National infrastructure used to create Recognised Air Pictures for Air Traffic Control and Defence Organisations.

Accordingly one aspect of the present invention provides a radar system comprising a filter operable to filter radar return signals received by a first radar receiver, based on radar return signals received at another radar receiver.

Another aspect of the present invention provides a method of filtering radar return signals to discriminate between targets of interest and clutter, in which a filter filters radar return signals received by a first radar receiver, based on radar return signals received at another radar receiver, to produce filtered radar return data in which radar return signals received by the first radar receiver for targets of interest are present and radar return signals received by the first radar receiver but arising from clutter are suppressed (or vice versa).

Another aspect of the present invention provides a radar system comprising a filter operable to filter radar return signals received by a first radar receiver, based on radar return signals received at another radar receiver, to produce filtered radar return data in which radar return signals received by the first radar receiver for targets of interest are present and radar return signals received by the first radar receiver but arising from clutter are suppressed (or vice versa).

Another aspect of the present invention provides a method of filtering radar return signals to discriminate between targets of interest and clutter, the method comprising: receiving signal data for radar return signals received at a first radar receiver, said radar return signals comprising signals arising from said targets of interest and signals arising from said clutter; receiving signal data for radar return signals received at a second radar receiver; and filtering said signal data for radar return signals received at said first radar receiver, in dependence on said signal data for radar return signals received at said second radar receiver, to produce filtered signal data in which one of: (i) the signal data for said signals arising from said clutter, and (ii) the signal data for said signals arising from said targets of interest, has been suppressed.

The step of receiving signal data for radar return signals received at a first radar receiver may comprise receiving signal data for radar return signals comprising signals arising from the targets of interest and/or signals arising from the clutter within a surveillance area. The step of receiving signal data for radar return signals received at a second radar receiver may comprise receiving signal data for radar return signals from within a cluttered region within the surveillance area. The cluttered region may comprise a predefined geographical region comprising, for example, a cluttered environment (as defined, for example, by predetermined azimuth and range boundaries). The cluttered region may comprise at least one wind turbine or at least one wind farm.

The filtering step may comprise comparing an apparent target position indicated by the signal data for a radar return signal received at the first radar receiver with an apparent target position indicated by the signal data for a radar return signal received at the second radar receiver.

The comparison may comprise determining whether the apparent target position indicated by the signal data for the radar return signal received at the first radar receiver is substantially coincident with the apparent target position indicated by the signal data for the radar return signal received at the second radar receiver. The comparison may comprise determining whether the apparent target position indicated by the signal data for the radar return signal received at the first radar receiver is substantially coincident with the apparent target position indicated by the signal data for the radar return signal received at the second radar receiver within a predetermined confidence limit.

If the apparent target position indicated by the signal data for the radar return signal received at the first radar receiver is not found to be substantially coincident with the apparent target position indicated by the signal data for the radar return signal received at the second radar receiver, then the signal data for the radar return signal received at the first radar receiver may be suppressed.

The filtering step may comprise filtering the signal data to produce filtered signal data in which the signal data for the signals arising from the clutter has been suppressed. The method may further comprise transforming the signal data for radar return signals received at the second radar receiver from a frame of reference associated with the second receiver to a frame of reference associated with the first radar receiver. The filtering step may comprise filtering the signal data for radar return signals received at the first radar receiver, in dependence on the signal data for radar return signals received at the second radar receiver as transformed to the frame of reference associated with the first radar receiver.

The signal data for radar return signals received at a first radar receiver may be received at a first update rate and the signal data for radar return signals received at a second radar receiver may be received at a second update rate wherein the second update rate is greater than the first update rate. The second rate may be at least five times or, optionally, at least ten times, at least twenty times, or at least forty times the first update rate or possibly greater. The second rate may, for example, be approximately forty times the first update rate.

The signal data for radar return signals received at a first radar receiver may be received at a first update rate and the signal data for radar return signals received at a second radar receiver may be received at a second update rate wherein the first update rate is greater than the second update rate. The first update rate may, for example, be at least twenty-five times or, optionally, at least fifty times, at least one hundred times, at least two hundred times, or at least four hundred times the second update rate or greater. The first update rate may be approximately one hundred times the second update rate.

The first radar receiver may be adapted to sweep a volume of interest at a sweep rate and wherein the second update rate is greater than the sweep rate. The second rate may, for example, be at least five times or, optionally, at least ten times, at least twenty times, or at least forty times the sweep rate or greater. The second rate may be approximately forty times the sweep rate.

The signal data for radar return signals received at the first and/or second radar receiver may comprise two dimensional data. The two dimensional data may comprise information from which a range and/or an azimuth can be determined for a source of the radar return signal which the signal data represents. The signal data for radar return signals received at the first and/or second radar receiver comprises may comprise three dimensional data. The three dimensional data may comprise information from which a range, an azimuth, and/or an angle of elevation, can be determined for a source of the radar return signal which the signal data represents.

The signal data for radar return signals received at the first radar receiver may be corrected to take account of range measurement errors. The filtering step may comprise filtering the signal data for the radar return signals received at the first radar receiver, in dependence on the signal data for the radar return signals received at the first radar receiver as corrected for by the range measurement errors.

The filtered signal data may be output to a display.

Another aspect of the present invention provides apparatus for filtering radar return signals to discriminate between targets of interest and clutter, the apparatus comprising: means for receiving signal data for radar return signals received at a first radar receiver, said radar return signals comprising signals arising from said targets of interest and signals arising from said clutter; means for receiving signal data for radar return signals received at a second radar receiver; and means for filtering said signal data for said radar return signals received at said first radar receiver, in dependence on said signal data for said radar return signals received at said second radar receiver, to produce filtered signal data in which one of: (i) the signal data for said signals arising from said clutter, and (ii) the signal data for said signals arising from said targets of interest, has been suppressed.

The means for receiving signal data for radar return signals received at a first radar receiver may be operable to receive signal data for radar return signals comprising signals arising from the targets of interest and signals arising from the clutter within a surveillance area. The means for receiving signal data for radar return signals received at a second radar receiver may be operable to receive signal data for radar return signals from within a cluttered region within the surveillance area. The means for receiving signal data for radar return signals received at a second radar receiver may be operable to receive signal data for radar return signals from within a cluttered region comprising a predefined geographical region comprising, for example, a cluttered environment (as defined, for example, by predetermined azimuth and range boundaries). The cluttered region may comprise at least one wind turbine or at least one wind farm.

The filtering means may be operable to compare an apparent target position indicated by the signal data for a radar return signal received at the first radar receiver with an apparent target position indicated by the signal data for a radar return signal received at the second radar receiver.

The filtering means may be operable, as part of the comparison, to determine whether the apparent target position indicated by the signal data for the radar return signal received at the first radar receiver is substantially coincident with the apparent target position indicated by the signal data for the radar return signal received at the second radar receiver.

The filtering means may be operable, as part of the comparison, to determine whether the apparent target position indicated by the signal data for the radar return signal received at the first radar receiver is substantially coincident with the apparent target position indicated by the signal data for the radar return signal received at the second radar receiver within a predetermined confidence limit.

The filtering means may be operable, if the apparent target position indicated by the signal data for the radar return signal received at the first radar receiver is not found to be substantially coincident with the apparent target position indicated by the signal data for the radar return signal received at the second radar receiver, to suppress the signal data for the radar return signal received at the first radar receiver.

The filtering means may be operable to filter the signal data to produce filtered signal data in which the signal data for the signals arising from the clutter has been suppressed.

The apparatus may further comprise means for transforming the signal data for radar return signals received at the second radar receiver from a frame of reference associated with the second receiver to a frame of reference associated with the first radar receiver. The filtering means may be operable to filter the signal data for radar return signals received at the first radar receiver, in dependence on the signal data for radar return signals received at the second radar receiver as transformed to the frame of reference associated with the first radar receiver.

The apparatus may be operable to receive the signal data for radar return signals received at a first radar receiver at a first update rate, and to receive the signal data for radar return signals received at a second radar receiver at a second update rate. The second update rate may be greater than the first update rate. The second rate may be at least five times or, optionally, at least ten times, at least twenty times, or at least forty times the first update rate or greater. The second rate may be approximately forty times the first update rate.

The apparatus may be operable to receive the signal data for radar return signals received at a first radar receiver at a first update rate, and to receive the signal data for radar return signals received at a second radar receiver at a second update rate. The first update rate may be greater than the second update rate. The first update rate may be at least ten, fifteen, twenty, or twenty-five times or, optionally, at least fifty times, at least one hundred times, at least two hundred times, or at least four hundred times the second update rate or greater. The first update rate may be approximately one hundred times the second update rate.

The second update rate may be greater than a sweep rate used by the first radar receiver to sweep a volume of interest. The second rate may be at least five times or, optionally, at least ten times, at least twenty times, or at least forty times the sweep rate or greater. The second rate may be approximately forty times the sweep rate.

The signal data for radar return signals received at the first and/or second radar receiver may comprise two dimensional data. The two dimensional data may comprise information from which a range and/or an azimuth can be determined for a source of the radar return signal which the signal data represents. The signal data for radar return signals received at the first and/or second radar receiver may comprise three dimensional data.

The three dimensional data may comprise information from which a range, an azimuth, and/or an angle of elevation, can be determined for a source of the radar return signal which the signal data represents.

The apparatus may further comprise means for correcting the signal data for radar return signals received at the first radar receiver to take account of range measurement errors, the filtering means potentially being operable to filter the signal data for the radar return signals received at the first radar receiver, in dependence on the signal data for the radar return signals received at the first radar receiver as corrected for the range measurement errors.

The apparatus may further comprise means for outputting the filtered signal data to a display.

The apparatus may be integrated as part of a primary surveillance radar.

The apparatus may be formed as (or as part of) a stand alone filter module.

Another aspect of the present invention provides a method of generating signal data for use in filtering radar return signals received at a first radar receiver to discriminate between targets of interest and clutter, the method comprising: receiving, at a second radar receiver, radar return signals from a cluttered environment, said radar return signals comprising signals arising from said targets of interest and signals arising from said clutter; discriminating between said signals arising from said targets of interest and said signals arising from said clutter; generating signal data for said signals arising from said targets of interest based on said discrimination, wherein said generated signal data is in a form suitable for use in filtering signal data for said radar return signals received at said first radar receiver, in dependence on said generated signal data, to produce filtered signal data in which one of: (i) the signal data for said signals arising from said clutter, and (ii) the signal data for said signals arising from said targets of interest, has been suppressed; and sending said generated signal data to apparatus for filtering said generated signal data accordingly.

Another aspect of the present invention provides radar apparatus for generating signal data for use in filtering radar return signals received at a first radar receiver to discriminate between targets of interest and clutter, the apparatus comprising: means for receiving, via a second radar receiver, radar return signals from a cluttered environment, said radar return signals comprising signals arising from said targets of interest and signals arising from said clutter; means for discriminating between said signals arising from said targets of interest and said signals arising from said clutter; means for generating signal data for said signals arising from said targets of interest based on said discrimination, wherein said generated signal data is in a form suitable for use in filtering signal data for said radar return signals received at said first radar receiver, in dependence on said generated signal data, to produce filtered signal data in which one of: (i) the signal data for said signals arising from said clutter, and (ii) the signal data for said signals arising from said targets of interest, has been suppressed; and means for sending said generated signal data to apparatus for filtering said generated signal data accordingly.

The filtered signal data may comprise signal data for radar return signals received at the first radar receiver and substantially no (or comparatively little) signal data for radar return signals received at the second radar receiver.

The invention will now be described by way of example only with reference to the attached figures in which:

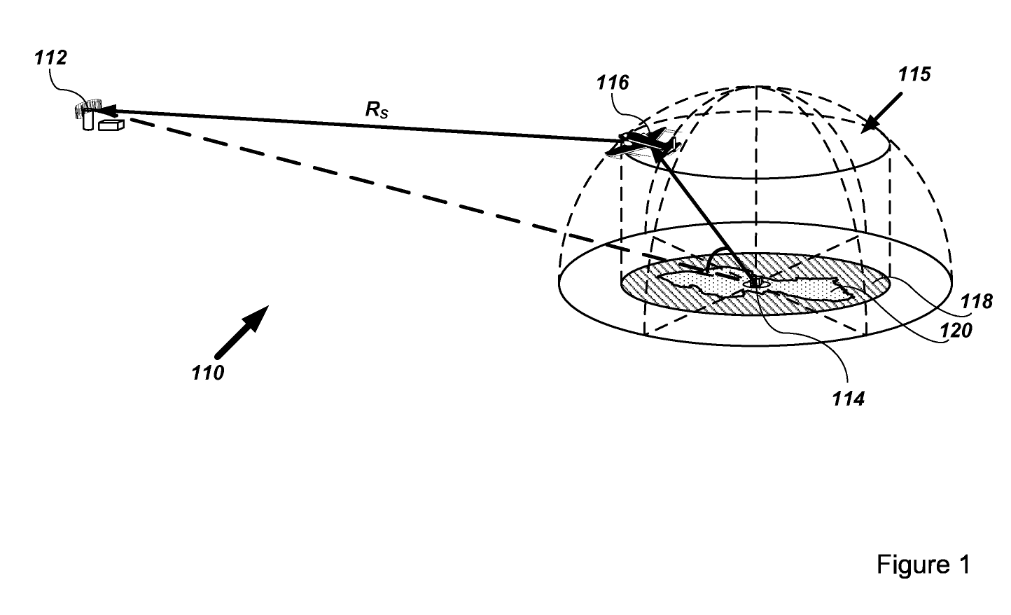

FIG. 1 shows an infill radar system incorporating an embodiment of the invention;

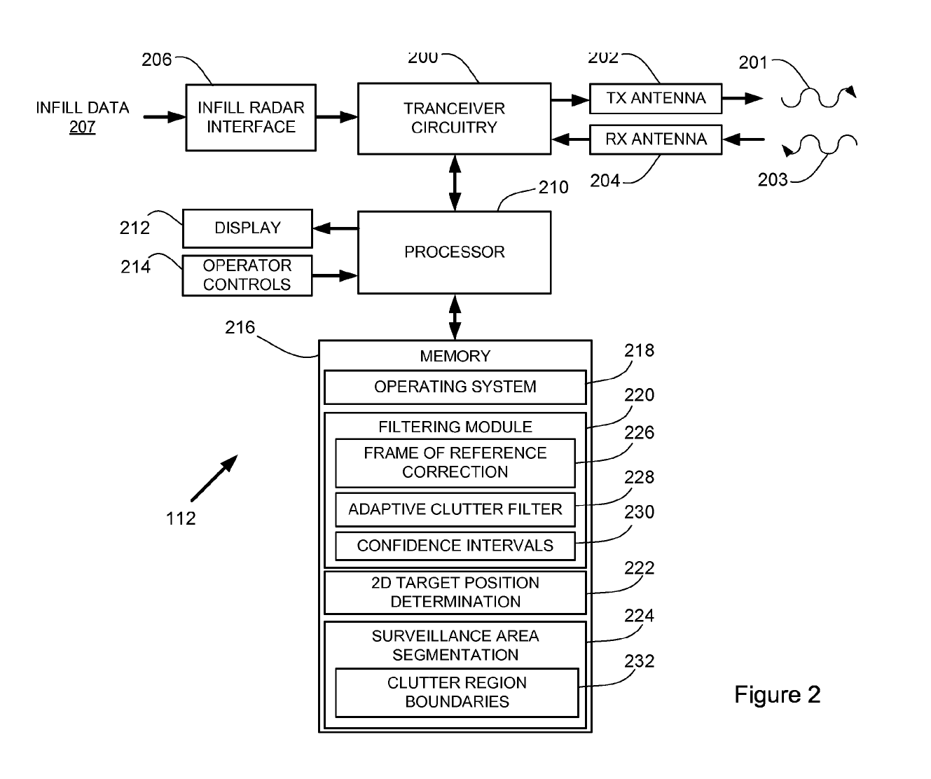

FIG. 2 schematically illustrates the main components of a primary surveillance radar (PSR) shown in FIG. 1;

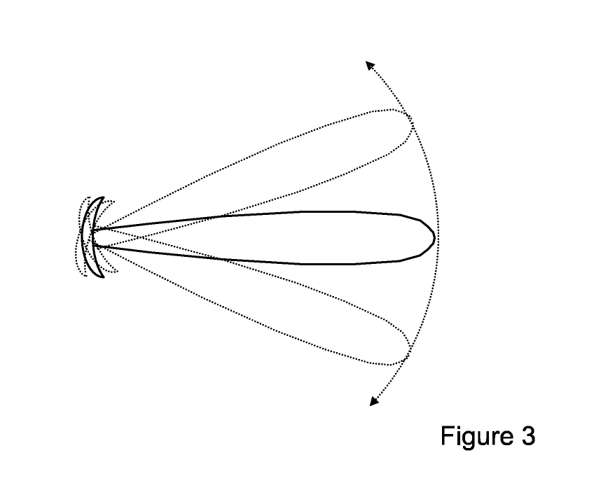

FIG. 3 illustrates the typical beam pattern of the primary surveillance radar (PSR) shown in FIG. 1;

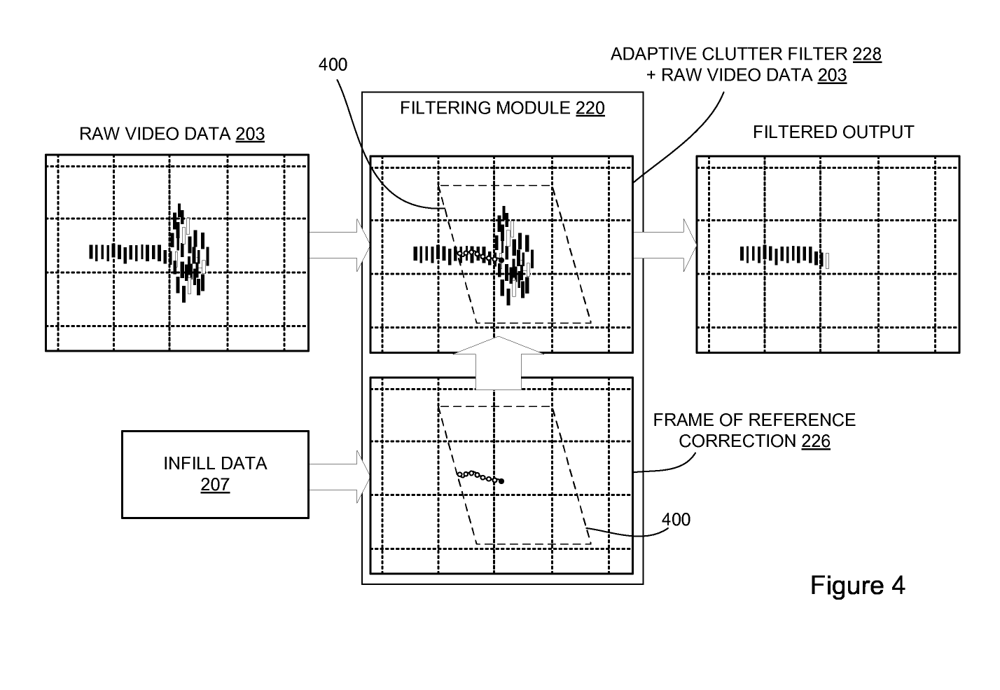

FIG. 4 illustrates operation of key features of a filtering module for use in the primary surveillance radar (PSR) shown in FIG. 1;

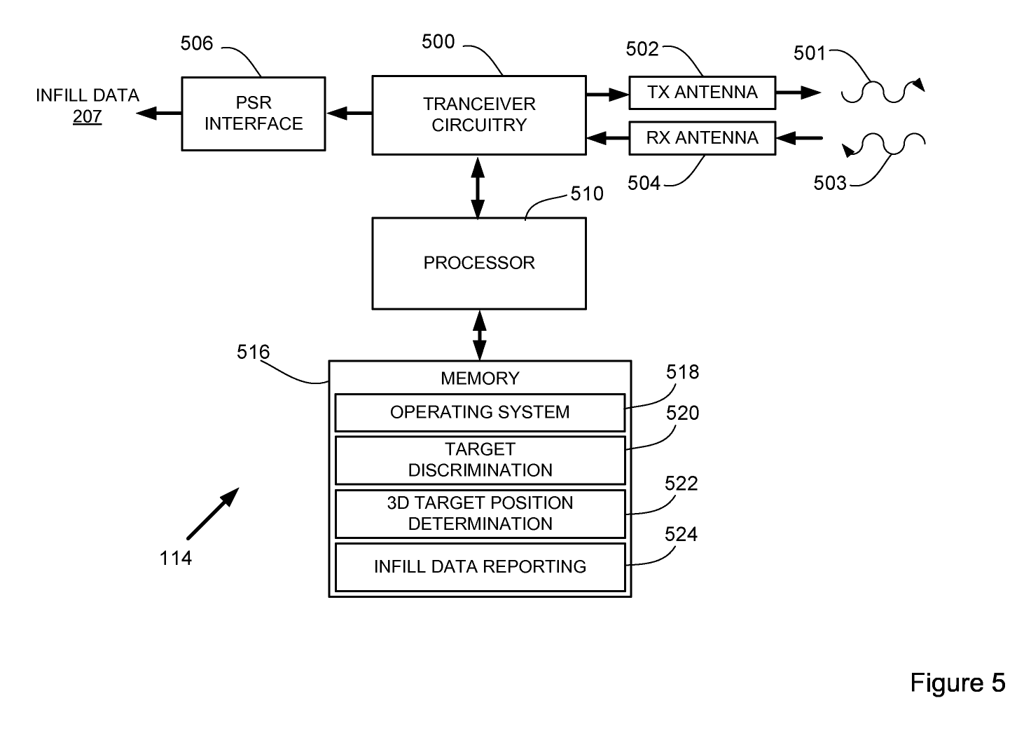

FIG. 5 schematically illustrates the main components of an infill radar shown in FIG. 1;

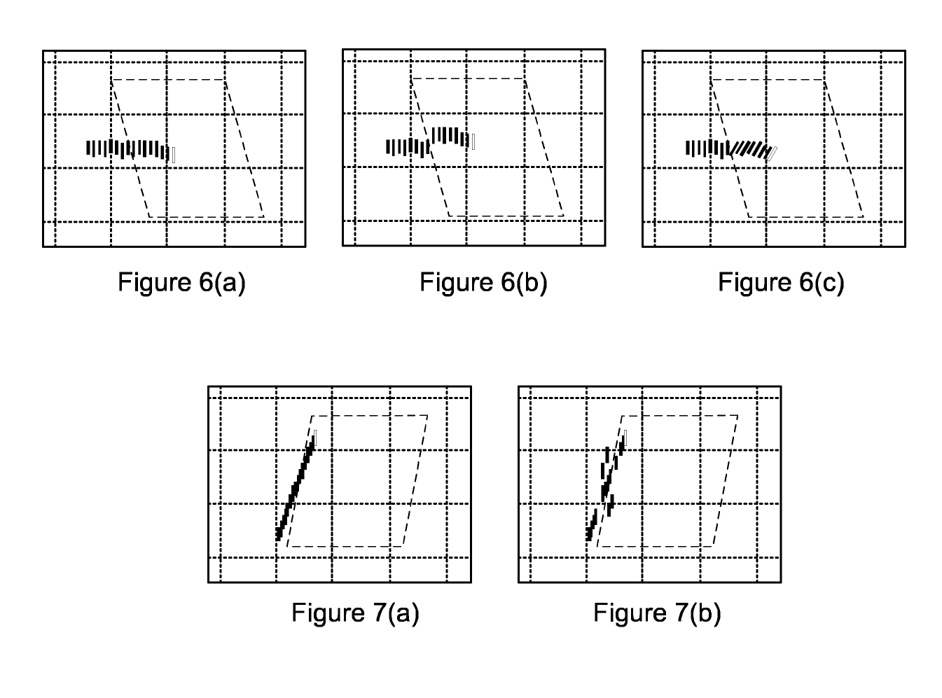

FIG. 6(a) shows, in simplified form, a typical display output from a primary surveillance radar (PSR) incorporating an embodiment of the invention in a first scenario;

FIGS. 6(b) and 6(c) show, in simplified form, potential display discontinuities which may be exhibited by a primary surveillance radar (PSR) in the first scenario, in the absence of the invention;

FIG. 7(a) shows, in simplified form, a typical display output from a primary surveillance radar (PSR) incorporating an embodiment of the invention in a second scenario; and

FIG. 7(b) shows, in simplified form, potential display discontinuities which may be exhibited by a primary surveillance radar (PSR) in the second scenario, in the absence of the invention.

### OVERVIEW

In FIG. 1 an exemplary infill radar system is shown generally at 110. The radar system 110 of this example comprises a primary surveillance radar (PSR) 112 and a secondary infill radar 114.

The primary surveillance radar (PSR) 112 of this embodiment comprises a two dimensional air traffic control radar which detects and monitors targets of interest 116, such as aircraft, within a surveillance area. The PSR 112 receives radar return signals reflected from a target 116 within the surveillance area, the raw radar return data (referred to as radar video data) is displayed on an operator's display at a position that is dependent on the range (e.g. the ‘slant’ range ‘R_{S}’) and azimuth of the target 116. The display position is therefore generally indicative of the two dimensional geographical position of an aircraft within known tolerances.

The infill radar 114 of this embodiment comprises a so called ‘holographic’ radar which is configured to illuminate a particular volume of space 115 persistently rather than in the discontinuous manner of scanning radar systems such as the PSR 112. Thus, information contained in signals returned from the volume being illuminated by the holographic radar is not lost as a result of such discontinuity. The holographic infill radar may, for example, be similar to that described in WO2009144435 (A1) the contents of which are hereby incorporated by reference.

The infill radar 114 is therefore capable of effectively discriminating between sources of clutter such as wind turbines and targets of interest 116 such as aircraft. Accordingly, the infill radar 114 is able to detect and monitor targets of interest 116, such as aircraft, in an infill region 118 within the surveillance area of the PSR, which infill region 118 includes a highly cluttered environment 120 (such as a wind farm) that has the potential to cause substantial interference to the PSR 112. The infill radar 114 is also capable of determining a three dimensional position of the targets 116, within known tolerances, in terms of their range, azimuth, and angle of elevation.

Rather than replace the raw video data of the PSR 112 with this infill data, however, the infill data from the infill radar 114 is instead provided as an input to a filtering module at the PSR 112. The filtering module applies a mathematical transformation to the data received from the infill radar 114 to transform it to a virtual reference frame which is coincident that of the PSR 112, thereby producing infill data which is consistent with the PSR's 112 frame of reference. Accordingly, the transformed infill data effectively comprises clean radar return data representing the target of interest 116, in which clutter related returns have been effectively suppressed, and in which the apparent position of the target of interest 116 is coincident (within the predetermined confidence limits) with the position it would be observed by the PSR in the absence of interference.

The filtering module comprises a clutter filter which is selectively used by the PSR for radar signals returned from a predefined geographical region comprising the highly cluttered environment 120 (as defined, for example, by predetermined azimuth and range boundaries). The clutter filter is used by the PSR to filter the raw video data, based on the transformed infill data, such that raw video data for which there is coincident infill data (within predefined confidence limits) is displayed, whilst raw video data for which there is no coincident infill data (within the predefined confidence limits) is suppressed. Accordingly, interference associated with the highly cluttered environment 120 is effectively removed from the raw video data. Contrastingly, a radar return received by the PSR 112 that indicates a target position which is substantially coincident with the position of a target 116, as reported by the infill radar 114 and transformed to the PSR's local frame of reference, is displayed.

The PSR 112 of the radar system 110 is therefore able identify whether or not a radar return received by the PSR is clutter (e.g. a wind turbine), or a target of interest (e.g. an aircraft) and to suppress or display the radar return accordingly.

### Primary Surveillance Radar

The primary surveillance radar 112 and its operation will now be described, by way of example only, with reference to FIGS. 2 to 4.

FIG. 2 schematically illustrates the main components of the primary surveillance radar (PSR) 112 shown in FIG. 1.

In this embodiment, the PSR 112 comprises transceiver circuitry 200 which comprises circuit modules for transmitting radar signals 201 into a surveillance region of interest via a transmitter antenna 202 (or antenna array) and comprises circuit modules for receiving radar return signals 203 returned from within the surveillance volume via a receiver antenna 204 (or antenna array). The PSR 112 has a relatively narrow field of view (for example, as illustrated in FIG. 3) and the antennas 202, 204 are therefore swept (or scanned) to allow the entire volume of interest to be illuminated, piecewise, in a sequential manner thereby effectively ‘chopping’ the signals received from the volume of interest at a rate determined by the sweep frequency. In this embodiment, for example, the volume of interest is illuminated by 4096 pulses per revolution (˜0.089° resolution in azimuth), and each revolution takes four seconds or so (˜1000 pulses per second (1 kHz)).

The transceiver circuit also comprises circuit modules for receiving the infill data 207 from the infill radar 114 via an infill radar interface 206.

As shown in FIG. 2, the PSR 112 also comprises at least one processor 210 operable to process the radar return signals 203 received via the transceiver circuitry 200 and to output the processed signals via a display 212 under the control of operator controls 214. The processor 210 operates in accordance with software instructions stored within memory 216. As shown, these software instructions provide, amongst other things, an operating system 218, the filtering module 220, a 2D target position determination module 222, and a surveillance area segmentation module 224.

The 2D target position determination module 222 is operable to determine the apparent 2D target positions (azimuth and range) which the radar returns 203 represent. The surveillance area segmentation module 224 is operable to effectively partition the volume of interest into at least one ‘low’ clutter region for which infill based filtering is not required, and at least one mitigation zone comprising a high clutter region (covered by the infill radar) for which infill based filtering is to be applied. The partitioning is based on predefined clutter region boundaries 232 represented, for example, by minimum and maximum ranges and azimuths for each region.

The filtering module 220 is operable to transform the 3D infill data 207 to the PSR's 2D frame of reference by applying a frame of reference correction algorithm 226 to the infill data 207 received from the infill radar 114. The frame of reference correction algorithm 226 applies, for example, trigonometric transformations to the infill data 207 based on the known position of the infill radar relative to the PSR 112, and the reported 3D position of the target 116 relative to the infill radar 114. Since, the infill radar can measure the angle of elevation, as well as azimuth and range, the errors normally associated with slant range measurements for 2D radar installations can be corrected for mathematically (by use of an appropriate trigonometric function). In this embodiment the correction is carried out automatically by the infill radar although it will be appreciated that a similar correction could be carried out by the filtering module 220 based on elevation, azimuth and ‘uncorrected’ range data received from the infill radar 114.

Referring to FIGS. 2 and 4 in particular, and as described previously, the filtering module 220 is also operable apply a clutter filter 228 to the raw radar return data 203 returned from the predefined mitigation zone (shown in FIG. 4 at 400), to filter out clutter related returns (e.g. from a wind turbine) based on a comparison of the apparent 2D target position represented by the raw radar return data 203, and the position of targets detected by the infill radar, as transformed to the PSR's frame of reference. If the apparent target position indicated by the raw radar return data 203 is coincident with the position (in the PSR's frame of reference) of a target detected by the infill radar (within predefined confidence intervals 230), then the raw radar return is output to the display 212. If, on the other hand, the apparent target position indicated by the raw radar return data 203 is not coincident with the position (in the PSR's frame of reference) of a target detected by the infill radar (within the predefined confidence intervals 230), then the raw radar return is suppressed.

In effect, therefore, the infill data 207 acts as ‘truth’ data which is used to adjust the clutter filter 228 ‘on-the-fly’ to allow radar returns relating to real targets through whilst suppressing clutter related radar returns. Advantageously, however, if a clutter return (such as a ‘flash’ from a turbine blade) coincides with the return from a genuine target of interest, the return is still displayed rather than being suppressed thereby avoiding inadvertent target suppression and associated degradation of information. Moreover, since it is the actual raw video data 203 that is displayed, rather than the infill data 207 any discrepancy between the target position as indicated by the raw video data 203 and the position indicated by the infill data 207 is substantially invisible to the operator.

### Infill Radar

The infill radar 114 shown in FIG. 1 and its operation will now be described, by way of example only, with reference to FIG. 5 which schematically illustrates the main components of the infill radar 114.

In this embodiment, as described previously, the infill radar comprises a three dimensional holographic radar similar to that described in WO2009144435 (A1).

The infill radar 114 comprises transceiver circuitry 500 which comprises circuit modules for transmitting radar signals 501 into a surveillance region of interest via a plurality of transmitter antennas 502 (in this embodiment four) and comprises circuit modules for receiving radar return signals 503 returned from within the surveillance volume via a plurality of receiver antennas 504 (in this embodiment four). The transmitter antennas 502 and receiver antennas 504 are arranged to provide the infill radar 114 with a plurality of different look directions (in this embodiment four).

The transmitter antennas 502 each comprise an array of transmitter antenna elements via which the infill radar 114 persistently illuminates the whole volume of interest, in the different look directions, with a coherent signal modulated appropriately (for example as a regular sequence of pulses) to permit range resolution. The transceiver circuitry is configured to illuminate targets in the region at a pulse rate (or pulse repetition frequency) sufficient to exceed the Nyquist limit for Doppler shifts associated with the targets.

The receiver antennas 504 each comprise a substantially planar array of receiver antenna elements each of which is capable of receiving signals returned from substantially the whole of the illuminated volume of interest. In this embodiment, the receiver antennas 504 each comprise 256 antenna elements arranged in a 16×16 array on a single substrate. It will be appreciated, however, that any suitable array dimensions and number of elements may be used.

The transceiver circuit also comprises circuit modules for transmitting the infill data 207 from the infill radar 114 to the PSR 112 via a PSR interface 506.

As shown in FIG. 5, the infill radar 114 also comprises at least one processor 510 operable to process the radar return signals 503 received via the transceiver circuitry 500. The processor 510 operates in accordance with software instructions stored within memory 516. As shown, these software instructions provide, amongst other things, an operating system 518, a target discrimination module 520, a 3D target position determination module 522, and an infill data reporting module 524.

The a target discrimination module 520 is operable to discriminate between radar returns associated with targets of interest such as aircraft and radar returns associated with clutter such as wind turbines. Such target discrimination is made possible by the persistent illumination of (as distinct from scanning) the whole volume of interest at the relatively high pulse rate, because it avoids the loss of information contained in the signals returned from the volume being illuminated that would otherwise arise.

The 3D target position determination module 522 is operable to determine the 3D target position (azimuth, elevation and range) which the radar returns 503 represent and, in this embodiment, to correct the errors normally associated with slant range measurements for 2D radar installations, mathematically using an appropriate trigonometric function.

The infill data reporting module 524 is operable to prepare the target information for communication to the PSR via the PSR interface 506.

The rate at which the infill radar 114 reports the data (in this embodiment 10 times every second or so) is significantly higher than the rate at which the PSR scans its surveillance volume (i.e. once every 4 seconds).

Accordingly, the use of a holographic radar, as opposed to a conventional scanning radar, as the infill radar allows the infill radar to be located at the heart of (or looking directly through) a highly cluttered environment rather than being positioned to avoid looking directly at the sources of interference such as wind turbines. Moreover, the holographic radar also allows accurate 3D positional data to be produced in which slant errors can be effectively eliminated and in which discrepancies associated with target movement are minimised.

### Exemplary Benefits

FIGS. 6(a) to 7(b) illustrate some of the potential benefits provided by the use of data from an infill radar to control filtering of radar returns received at a primary surveillance radar.

FIGS. 6(a) and 7(a) each illustrate, in simplified form, for different respective target/mitigation zone scenarios, the clean filtered output data that may be expected from the use of the infill radar to manage filtering of the raw data. As shown, because it is still the actual PSR data that is being displayed (albeit filtered) the returns exhibit no discontinuity at the boundary of the mitigation zone. FIGS. 6(b), 6(c), and 7(b) each illustrate, in simplified form, different respective discontinuities which may occur at the boundary if infill data is used to simply replace the raw PSR data at the boundary of the mitigation zone. These discontinuities may arise, for example, from slant errors, from discrepancies arising from the different geometric frames reference of the PSR and the infill radar, from errors arising from the movement of high velocity targets etc.

### Modifications and Alternatives

A detailed embodiment has been described above. As those skilled in the art will appreciate, a number of modifications and alternatives can be made to the above embodiment whilst still benefiting from the inventions embodied therein. By way of illustration only a number of these alternatives and modifications will now be described.

It will be appreciated that, whilst the clutter filter has been described as part of an integrated system, the clutter filter 228 may comprise a ‘standalone’ hardware or software filter module which is effectively located between an output of a primary surveillance radar and an input of a video display or the like. Such a filter module may, for example, be adapted to receive a first input comprising raw or processed radar return signals from a primary surveillance radar, and a second input comprising raw or processed radar return signals from an infill radar. In such an embodiment, the filter module processes the two input signals to filter out those signals, from the primary surveillance radar receiver, relating to targets which do not have corresponding targets represented by return signals from the infill radar. The filtered signals are then output for display via the video display substantially as described previously. For example, the filter module 220 shown in FIG. 4 (or part of it) may be provided as a standalone module.

The filter module may also form part of a separate display system for a primary surveillance radar, rather than part of the PSR itself.

It will also be appreciated that the clutter filter may be arranged to process the signals received by the PSR, and to filter them based on the infill data, either as the signals are received from anywhere in entire volume being scanned (e.g. at a data rate of ˜1 kHz in the above embodiment), or as the signals received for each segment of azimuth resolution are processed (e.g. once every revolution or ˜0.25 Hz in the above embodiment).

Reporting the infill data at a rate which is significantly higher than the rate at which the PSR scans its surveillance volume is particularly beneficial in situations in which the clutter filter integrates the infill data with the PSR data for each of the 4096 (˜0.089°) segments of revolution separately (which is updated once every revolution). For example, a relatively high infill data rate in this case can help to ensure that any discrepancies associated with the movement of a high velocity target, between the infill data being reported and the region to which the infill data relates being scanned by the PSR 112, are minimised. In the described embodiment, for example, the maximum discrepancy between the PSR's position measurement and the infill radar's position measurement would be 0.1 seconds which is equivalent to approximately 20 m in range for a target moving at 200 m/s towards the radars 112, 114. Moreover, the high reporting rate can allow any measurement errors in the infill data to be averaged out over the many reporting intervals (in this embodiment 40 or so) between PSR sweeps. For example, in this embodiment, the three sigma (3σ) range, azimuth and elevation errors can be reduced by an approximate factor of three.

It will be further appreciated that the PSR may scan the volume of interest at any suitable rate (e.g. 1 Hz, 0.5 Hz, 0.25 Hz, 0.125 Hz etc.) with any suitable azimuth resolution (e.g. 512, 1024, 2048, 4096, 8192 pulses per revolution, or the like).

In the embodiments described above, the PSR and infill radar each include transceiver circuitry. Typically this circuitry will be formed by dedicated hardware circuits. However, in some embodiments, part of the transceiver circuitry may be implemented as software run by a corresponding controller (for example the corresponding processor).

In the above embodiment, a number of software modules were described. As those skilled will appreciate, the software modules may be provided in compiled or un-compiled form and may be supplied to the radars as signals over a computer network, or as instructions stored on a recording medium. Further, the functionality performed by part or all of this software may be performed using one or more dedicated hardware circuits. However, the use of software modules is preferred as it facilitates updating the radar software in order to update their functionalities. Further, the modules described above may not be defined as separate modules and may instead be built in to the corresponding operating system.

In the above description, the radars are each described, for ease of understanding, as having a number of discrete modules. Whilst these modules may be provided in this way for certain applications, for example where an existing system has been modified to implement the invention, in other applications, for example in systems designed with the inventive features in mind from the outset, these modules may be built into the overall operating system or code and so these modules may not be discernible as discrete entities. Where separate modules are provided, the functionality of one or more of the above modules may be performed by a single module.

Communication of infill data between the radars may use any suitable wireless or wired communication protocol and associated technology. For example where the radars are located at a relatively large distance from one another, the radars may be configured for communication via a communication network such as a conventional mobile telephone network (e.g. via base station, radio network controller, core network etc). Alternatively or additionally, the radars may be configured for communication via a computer network, such as the internet (e.g. via wired or wireless connection to a suitable access point)

It will be appreciated that although the infill area monitored by the infill radar in the above embodiment is described as being located within the surveillance area, the infill area may cover an area which is outside the surveillance area or which partially overlaps with it. This scenario may apply, for example, where the infill area is fully or partially obscured from the line of site of the PSR by the local terrain (e.g. in the radar shadow of a mountains, hills or even a man made structure). Moreover, the infill area may be beyond the normal range of the surveillance radar, for example where the infill radar is located on a ship and is designed to give advance warning of approaching targets.

It will be appreciated that while the primary surveillance radar is described as being two dimensional the principles of the invention could be applied to a three dimensional primary surveillance radar. Moreover, whilst the primary surveillance radar has been described in terms of a air traffic control radar the primary surveillance radar may comprise any appropriate form of radar for example an air defence radar, a shipboard or terrestrial based marine radar, or the like.

Whilst it is particularly beneficial for the infill radar to comprise a 3D radar sensor such as that described in WO2009144435 (A1), the ‘clutter free’ infill radar could comprise a second scanning PSR which has unhindered sight of the airspace above the cluttered environment, but not the sources of radar interference themselves, for example, due to terrain masking or simply the orientation of the scanning beam. A scanning PSR based infill radar could potentially be used, for example, if the confidence intervals set within the filter are sufficiently large to allow for the relatively large discrepancies in the apparent target position (as indicated for the same target by the two different PSR's).

Discrepancies in the reported position may arise, for example, from the different slant range errors associated with the respective elevation angles of a particular target relative to each PSR. Discrepancies may also arise from errors associated with target movement within the relatively large time intervals that may occur between respective radar reports for a particular target, from each of the two PSR's, especially where the target is a high velocity target such as a high speed aircraft or missile.

In the described embodiment the transformation of the infill data to the PSR's frame of reference is described as taking place in the filtering module at the PSR. Whilst this approach is particularly beneficial (for example where the infill data is provided to a plurality of different PSR's, each PSR its own frame of reference), it will be appreciated, that the transformation or aspects of it could potentially be carried out by appropriate signal processing functionality at the infill radar itself (where the infill radar is provided with sufficient information to derive the PSR's frame of reference).

It will be appreciated that the use of infill radars is scalable to cover any size, shape, or number of cluttered environments. For example, where there are a large number of cluttered areas (e.g. each containing a wind farm) in line of sight with of PSR, or where a cluttered area is particularly large, then the output of a plurality of infill radars covering each (or the entire) cluttered area may be combined into a single data feed to the filter module of the PSR.

It will be appreciated that whilst the embodiment described is concerned with the suppression of radar signals arising from clutter by filtering based in infill data, a similar technique could be used in which signals from targets of interest are suppressed by the filter, based on the infill data, to produce an output that is indicative of clutter in the region (e.g. a clutter map or the like).

Whilst the embodiment was described primarily with reference to cluttered environments comprising wind turbines and wind farms it will be appreciated that embodiments of the invention could be beneficially applied in many different scenarios. The cluttered environment may, for example, include one, some or all of the following: an individual wind turbine (whether off-shore or on-shore), a wind farm, a collection of wind farms, a ship or groups of ships, terrestrial vehicles or groups thereof, sea clutter, buildings and other similar major structures, especially ports, docks, marinas or harbours or the like. Similarly, targets of interest may include manned and/or unmanned aircraft, missiles, road and/or off-road vehicles, people, pedestrians, boats, ships, submarines or the like.

Various other modifications will be apparent to those skilled in the art and will not be described in further detail here.

Each feature disclosed in this specification (which term includes the claims) and/or shown in the drawings may be incorporated in the invention independently (or in combination with) any other disclosed and/or illustrated features. In particular but without limitation the features of any of the claims dependent from a particular independent claim may be introduced into that independent claim in any combination or individually.

Statements in this specification of the “objects of the invention” relate to preferred embodiments of the invention, but not necessarily to all embodiments of the invention falling within the claims.

The description of the invention with reference to the drawings is by way of example only.

Any feature in one aspect of the invention may be applied to other aspects of the invention, in any appropriate combination. In particular, method aspects may be applied to apparatus aspects, and vice versa.

Furthermore, features implemented in hardware may generally be implemented in software, and vice versa. Any reference to software and hardware features herein should be construed accordingly.

The text of the abstract filed herewith is repeated here as part of the specification. In an exemplary aspect of the invention of the invention there is provided a method of filtering radar return signals to discriminate between targets of interest and clutter in which a filter filters radar return signals received by a first radar receiver, based on radar return signals received at another radar receiver, to produce filtered radar return data in which radar return signals received by the first radar receiver for targets of interest are present and radar return signals received by the first radar receiver but arising from clutter are suppressed.

1. (canceled)

2. A method of filtering radar return signals to discriminate between targets of interest and clutter, the method comprising:
receiving signal data for radar return signals received at a first radar receiver, said radar return signals comprising signals arising from said targets of interest and signals arising from said clutter;
receiving signal data for radar return signals received at a second radar receiver; and
filtering said signal data for said radar return signals received at said first radar receiver, in dependence on said signal data for said radar return signals received at said second radar receiver, to produce filtered signal data in which one of: (i) the signal data for said signals arising from said clutter, and (ii) the signal data fir said signals arising from said targets of interest, has been suppressed.

3. The method as claimed in claim 2 wherein:
said step of receiving signal data for radar return signals received at a first radar receiver comprises receiving signal data for radar return signals comprising signals arising from said targets of interest and signals arising from said clutter within a surveillance area; and
said step of receiving signal data for radar return signals received at a second radar receiver comprises receiving signal data for radar return signals from within a cluttered region within said surveillance area.

4. The method as claimed in claim 3 wherein said cluttered region comprises a predefined geographical region comprising a cluttered environment (as defined, for example, by predetermined azimuth and range boundaries).

5. The method as claimed in claim 3 wherein said cluttered region comprises at least one wind turbine or at least one wind farm.

6. The method as claimed in claim 2 wherein said filtering step comprises comparing an apparent target position indicated by said signal data for a radar return signal received at said first radar receiver with an apparent target position indicated by said signal data for a radar return signal received at said second radar receiver.

7. The method as claimed in claim 6 wherein said comparison comprises determining whether said apparent target position indicated by said signal data for said radar return signal received at said first radar receiver is substantially coincident with said apparent target position indicated by said signal data for said radar return signal received at said second radar receiver.

8. The method as claimed in claim 7 wherein said comparison comprises determining whether said apparent target position indicated by said signal data for said radar return signal received at said first radar receiver is substantially coincident with said apparent target position indicated by said signal data for said radar return signal received at said second radar receiver within a predetermined confidence limit.

9. The method as claimed in claim 7 wherein, if said apparent target position indicated by said signal data for said radar return signal received at said first radar receiver is not found to be substantially coincident with said apparent target position indicated by said signal data for said radar return signal received at said second radar receiver, then said signal data for said radar return signal received at said first radar receiver is suppressed.

10. The method as claimed claim wherein said filtering step comprises filtering said signal data to produce filtered signal data in which the signal data for said signals arising from said clutter has been suppressed.

11. The method as claimed in claim 2 wherein said method further comprises transforming said signal data for radar return signals received at said second radar receiver from a frame of reference associated with said second receiver to a frame of reference associated with said first radar receiver.

12. The method as claimed in claim 11 wherein said filtering step comprises filtering said signal data for radar return signals received at said first radar receiver, in dependence on said signal data for radar return signals received at said second radar receiver as transformed to the frame of reference associated with said first radar receiver.

13. The method as claimed in claim 2 wherein said signal data for radar return signals received at a first radar receiver is received at a first update rate and said signal data for radar return signals received at a second radar receiver is received at a second update rate wherein said second update rate is greater than said first update rate.

14. The method as claimed in claim 13 wherein said second rate is at least five times or, optionally, at least ten times, at least twenty times, or at least forty times the first update rate or greater.

15. The method as claimed in claim 13 wherein said second rate is approximately forty times the first update rate.

16. The method as claimed in claim 2 wherein said signal data for radar return signals received at a first radar receiver is received at a first update rate and said signal data for radar return signals received at a second radar receiver is received at a second update rate wherein said first update rate is greater than said second update rate.

17. The method as claimed in claim 16 wherein said first update rate is at least ten, fifteen, twenty, or twenty-five times or, optionally, at least fifty times, at least one hundred times, at least two hundred times, or at east four hundred times the second update rate or greater.

18. The method as claimed in claim 16 wherein said first update rate is approximately one hundred times the second update rate.

19. The method as claimed in claim 13 wherein said first radar receiver is adapted to sweep a volume of interest at a sweep rate and wherein said second update rate is greater than said sweep rate.

20. The method as claimed in claim 13 wherein said second rate is at least five times or, optionally, at least ten times, at least twenty times, or at least forty times the sweep rate or greater.

21. The method as claimed in claim 13 wherein said second rate is approximately forty times the sweep rate.

22. The method as claimed in claim 2 wherein said signal data for radar return signals received at said first and/or second radar receiver comprises two dimensional data.

23. The method as claimed in claim 22 wherein said two dimensional data comprises information from which a range and/or an azimuth can be determined for a source of the radar return signal which the signal data represents.

24. The method as claimed in claim 2 wherein said signal data for radar return signals received at said first and/or second radar receiver comprises three dimensional data.

25. The method as claimed in claim 24 wherein said three dimensional data comprises information from which a range, an azimuth, and/or an angle of elevation, can be determined for a source of the radar return signal which the signal data represents.

26. The method as claimed in claim 2 further comprising correcting said signal data for radar return signals received at said first radar receiver to take account of range measurement errors, said filtering step comprising filtering said signal data for said radar return signals received at said first radar receiver, in dependence on said signal data for said radar return signals received at said first radar receiver as corrected for said range measurement errors.

27. The method as claimed in claim 2 further comprising outputting said filtered signal data to a display.

28. A computer program, stored on a non-transitory computer readable medium comprising instructions that, when executed on a processor perform a method of filtering radar return signals to discriminate between targets of interest and clutter, the method comprising:
receiving signal data for radar return signals received at a first radar receiver, said radar return signals comprising signals arising from said targets of interest and signals arising from said clutter;
receiving signal data for radar return signals received at a second radar receiver; and
filtering said signal data for said radar return signals received at said first radar receiver, in dependence on said signal data for said radar return signals received at said second radar receiver, to produce filtered signal data in which one of: (i) the signal data for said signals arising from said clutter, and (ii) the signal data for said signals arising from said targets of interest, has been suppressed.

29. An apparatus for filtering radar return signals to discriminate between targets of interest and clutter, the apparatus comprising:
means for receiving signal data for radar return signals received at a first radar receiver, said radar return signals comprising signals arising from said targets of interest and signals arising from said clutter;
means for receiving signal data for radar return signals received at a second radar receiver; and
means for filtering said signal data for said radar return signals received at said first radar receiver, in dependence on said signal data for said radar return signals received at said second radar receiver, to produce filtered signal data in which one of: (i) the signal data for said signals arising from said clutter, and (ii) the signal data for said signals arising from said targets of interest, has been suppressed.

30.-54. (canceled)

55. The apparatus as claimed in claim 29 when integrated as part of a primary surveillance radar.

56. The apparatus as claimed in claim 29 formed as (or as part of) a stand alone filter module.

57. A method of generating signal data for use in filtering radar return signals received at a first radar receiver to discriminate between targets of interest and clutter, the method comprising:
receiving, at a second radar receiver, radar return signals from a cluttered environment, said radar return signals comprising signals arising from said targets of interest and signals arising from said clutter;
discriminating between said signals arising from said targets of interest and said signals arising from said clutter;
generating signal data for said signals arising from said targets of interest based on said discrimination, wherein said generated signal data is in a form suitable for use in filtering signal data for said radar return signals received at said first radar receiver, in dependence on said generated signal data, to produce filtered signal data in which one of: (i) the signal data for said signals arising from said clutter, and (ii) the signal data for said signals arising from said targets of interest, has been suppressed; and
sending said generated signal data to apparatus for filtering said generated signal data.

58. A radar apparatus for generating signal data for use in filtering radar return signals received at a first radar receiver to discriminate between targets of interest and clutter, the apparatus comprising:
means for receiving, via a second radar receiver, radar return signals from a cluttered environment, said radar return signals comprising signals arising from said targets of interest and signals arising from said clutter;
means for discriminating between said signals arising from said targets of interest and said signals arising from said clutter;
means for generating signal data for said signals arising from said targets of interest based on said discrimination, wherein said generated signal data is in a form suitable for use in filtering signal data for said radar return signals received at said first radar receiver, in dependence on said generated signal data, to produce filtered signal data in which one of: (i) the signal data for said signals arising from said clutter, and (ii) the signal data for said signals arising from said targets of interest, has been suppressed; and
means for sending said generated signal data to apparatus tier filtering said generated signal data.
